(19) United States
(12) Patent Application Publication
(10) Pub. No.: US 2013/0170778 A1
(43) Pub. Date: Jul. 4, 2013

(54) ANGLED BEARING ASSEMBLY

(71) Applicants: James Robbie Higginbotham, The Woodlands, TX (US); Mark Chustz, Porter, TX (US)

(72) Inventors: James Robbie Higginbotham, The Woodlands, TX (US); Mark Chustz, Porter, TX (US)

(73) Assignee: Scientific Drilling International, Inc., Houston, TX (US)

(21) Appl. No.: 13/806,865

(22) PCT Filed: Jun. 29, 2010
(86) PCT No.: PCT/US10/40455

§ 371 Date: Mar. 15, 2013

(51) Int. Cl. F16C 33/58; F16C 33/62

(52) U.S. Cl. CPC F16C 33/585; F16C 33/62
USPC 384/513; 384/569

(57) ABSTRACT

A bearing assembly includes a first race having a first set recesses disposed on an upper surface thereof. Wherein a first set of bearing elements are disposed within the first set of recesses and the first set of bearing elements extend upwardly from the first set of recesses at an inclination relative to a vertical axis of the first race. A second race having a second set of recesses disposed on an upper surface thereof. A second set of bearing elements are disposed within the second set of recesses and the second set of bearing elements extend upwardly from the second set of recesses at an inclination relative to a vertical axis of the second race.

### BACKGROUND

The present disclosure relates generally to bearing assemblies.

Bearings support other parts of rotary equipment. For example, rolling element bearings include ball bearings, roller bearings, spherical, and tapered roller bearings. Ball bearings and roller bearings have spherical and cylindrical roller elements, respectively, disposed between two concentric ring-shaped members, or races.

A thrust bearing includes a pair of radial surfaces with rolling elements therebetween. In rolling element bearings, a plurality of roller elements, such as spherical roller elements, or balls, are confined between first and second races. In the case of a bearing which provides restraint of radial loads, the races would define inner and outer races. Free motion is accomplished between the two races through the rolling of the roller elements against a first load support surface of a second race. As such, the roller elements are sized to a rolling diameter suitable for being retained in a rolling relationship between the races. The roller elements may be retained in a spaced arrangement relative to one another through the use of one or more types of support structures, such as a cage.

Although ball bearings provide radial and axial support, ball bearings tend to wear out quickly. Therefore, there is a need for bearings that provide radial and axial support and are capable of being in service longer than ball bearings.

### SUMMARY

A bearing assembly includes a first race having a first set of recesses disposed on an upper surface thereof. Wherein a first set of bearing elements are disposed within the first set of recesses and the first set of bearing elements extend upwardly from the first set of recesses at an inclination relative to a vertical axis of the first race. A second race having a second set of recesses disposed on an upper surface thereof. A second set of bearing elements are disposed within the second set of recesses and the second set of bearing elements extend upwardly from the second set of recesses at an inclination relative to a vertical axis of the second race.

These and other objects and advantages of the invention, as well as the details of an illustrative embodiment, will be more fully understood from the following specification and figures:

### BRIEF DESCRIPTION OF THE DRAWINGS

FIG. 1 illustrates a plan view of bearing race of an inner thrust bearing;

FIG. 2 illustrates an sectional view of the bearing race of FIG. 1;

FIG. 3 illustrates a plan view of bearing race of an outer thrust bearing;

FIG. 4 illustrates a sectional view of the bearing race of FIG. 3;

FIG. 5 shows a view of a combined bearing assembly of the present disclosure;

FIG. 6 illustrates a side view of down-hole assembly of the present disclosure; and

FIG. 7 depicts an exploded sectional view of the down-hole assembly of FIG. 6 taken along the section line 7-7.

### DETAILED DESCRIPTION OF THE DRAWINGS

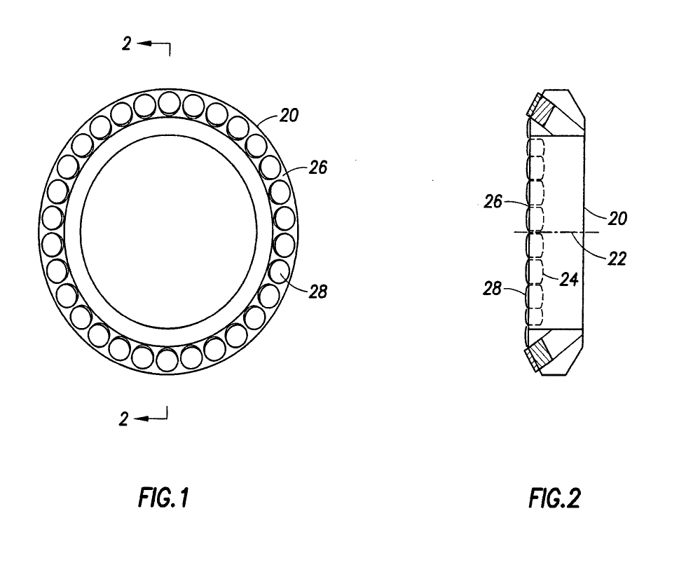

With reference to FIGS. 1 and 2, a first bearing race 20 has a first axis 22. A first set of recesses 24 are disposed around a circumference of a first top surface 26. A first set of bearing elements 28 are disposed within the recesses 24. The bearing elements 28 are inclined at an angle relative to the first axis 22.

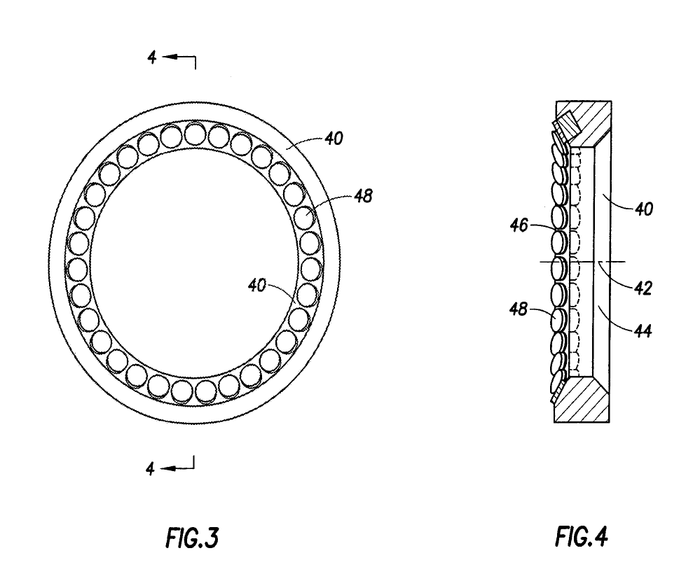

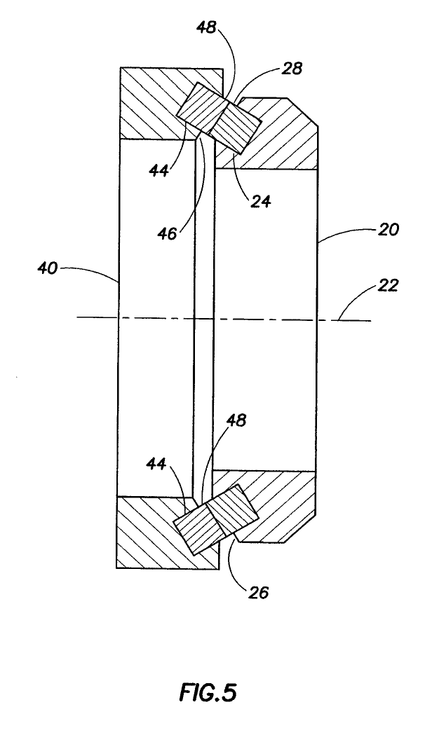

Similarly FIGS. 3 and 4 show a second bearing race 40 has a second axis 42. A second set of recesses 44 disposed around a circumference of a second top surface 46. A second set of bearing elements 48 are disposed within the recesses 44. The bearing elements 48 are inclined at an angle relative to the second axis 42.

The bearing elements 28, 48 can be made of materials such as polycrystalline diamond, tungsten carbide, ceramics or synthetic diamond. Other suitable materials will be apparent to those of skill in the art in light of the present disclosure. Further, those of ordinary skill in the art will understand that bearing elements 28 and 48 can be disposed within recesses 24 and 44 by several techniques. For example, the bearing elements 28, 48 can be disposed in the recesses 24, 44 by brazing or by mechanical means such as pressing.

In use, the first and second bearing races 20, 40 are juxtaposed such that the axes 22 and 42 are aligned and the bearing elements 28 and 48 are arranged in opposing relation as shown in the combined bearing 60 of FIG. 5. Such arrangement allows the combined bearing 60 to provide radial and axial support for moving parts of rotating equipment that may be utilized with the bearing 60 when such equipment is in operation.

In one embodiment, drilling motors that are used to drill boreholes are typically subjected to radial and axial loading forces while drilling. Such motors require bearings that can provide radial and axial support to counteract radial and axial forces and to support a drill bit that is attached to the distal end of the motor. The combined bearing 20 of the present disclosure is capable of being in service longer than ball bearings and takes up less axial space than typical bearings. The reduced axial space that is required by the bearing 20 is critical to shorten the bit to bend length of a bottom hole assembly.

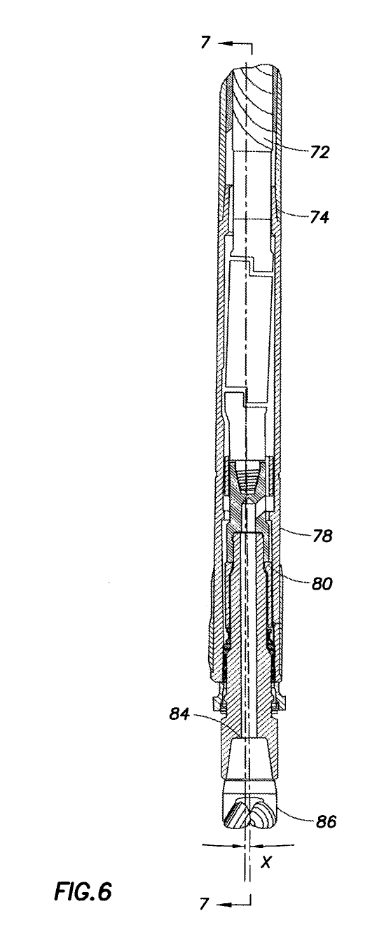

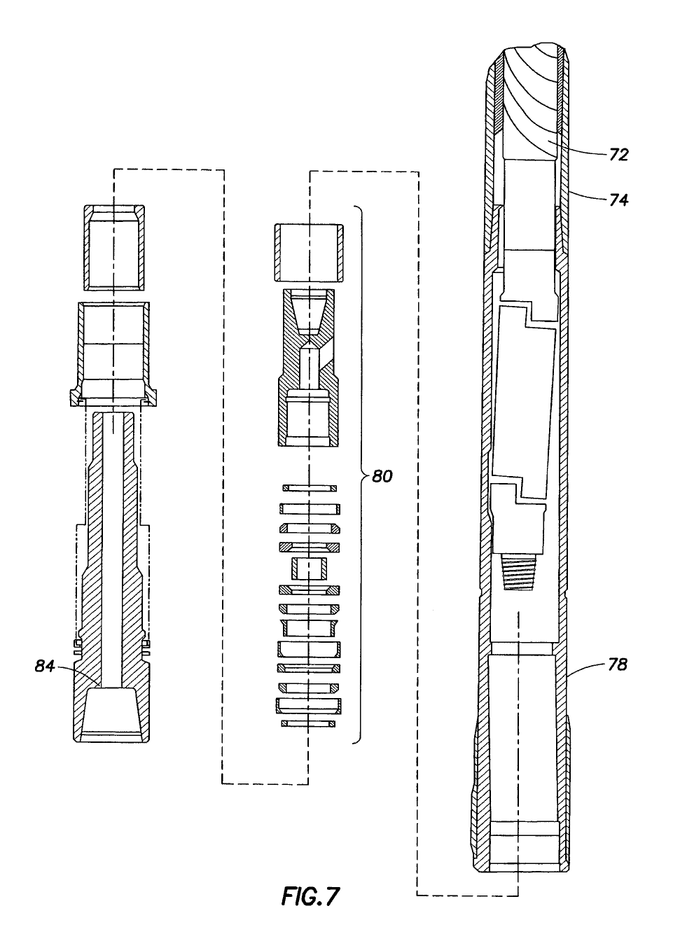

Turning now to FIGS. 6-7, a bottom hole assembly 70 includes a power section 72 disposed within a power section housing 74. A bearing housing 78 is provided to receive a bearing assembly 80. As will be understood by those of skill in the art, the bearing assembly 80 may include any type of suitable bearing known in the art may be employed with the present disclosure. Such bearings include but are not limited to ball bearings, polycrystalline diamond thrust bearings, roller bearings, open flow, or sealed bearings.

In one embodiment, the combined bearing 60 of FIG. 5 may be employed in order to realize the benefits of radial and axial support discussed above with respect to FIG. 5. In such embodiments, the combined bearing 60 provides adequate radial and axial support output shaft 84 and drill bit 86 attached thereto.

What is claimed is:

1. A bearing assembly including
a first race having a first set recesses disposed on an upper surface thereof;
wherein a first set of bearing elements are disposed within the first set of recesses and the first set of bearing elements extend upwardly from the first set of recesses at an inclination relative to a vertical axis of the first race;
a second race having a second set of recesses disposed on an upper surface thereof; and
wherein a second set of bearing elements are disposed within the second set of recesses and the second set of bearing elements extend upwardly from the second set of recesses at an inclination relative to a vertical axis of the second race.

2. The bearing assembly of claim 1, wherein the bearing elements are polycrystalline diamond elements.

3. The bearing assembly of claim 1, wherein the bearing elements are tungsten carbide elements.

4. The bearing assembly of claim 1, wherein the bearing elements are ceramic elements.

5. The bearing assembly of claim 1, wherein the bearing elements are synthetic diamonds elements.

6. The bearing assembly of claim 1, wherein the bearing elements are installed by brazing.

7. The bearing assembly of claim 1, wherein the bearing elements are mechanically pressed into the recesses.
